(19) United States
(12) Patent Application Publication
(10) Pub. No.: US 2006/0074555 A1
(43) Pub. Date: Apr. 6, 2006

(54) Navigational systems, methods and devices

(75) Inventors: Eric Liu, Walnut, CA (US); Xinjun Yang, Brea, CA (US)

Correspondence Address: FOLEY & LARDNER LLP, P.O. BOX 80278, SAN DIEGO, CA, 92138-0278, US

(73) Assignee: Pryme Advance Corp.

(21) Appl. No.: 10/957,209

(22) Filed: Oct. 1, 2004

(51) Int. Cl. G01C 21/30

(52) U.S. Cl. 701/213; 701/208; 340/995.12

(57) ABSTRACT

Devices, methods and systems for providing electronic navigation are disclosed. Map data can be downloaded from a server through a network, such as the Internet or a cellular telephone network, onto a portable device. A route may be calculated based on the map data for a starting point and a destination provided by the user. The portable device may include a GPS-enabled module for determining the current positional data. The portable device is able to generate directional instructions based on the map data and the current positional information and to provide the user with directional instructions, such as instructions to turn left or right. In one aspect, a navigational system includes a map data server adapted to provide map data to requesting clients through a communication network and a portable device adapted to receive map data from the map data server through the communication network and to provide directional instructions to a user. The portable device includes a map data module adapted to receive the map data from the map data server and a navigational module adapted to receive current positional information and to generate directional instructions based on the map data and the current positional information.

### BACKGROUND OF THE INVENTION

The present invention relates generally to the field of navigational systems. In particular, the invention relates to systems, methods and devices for providing electronic navigation.

Navigational systems are becoming readily available in numerous forms. For example, multiple web sites offer interactive map information, including driving directions between two points. Such directions can be printed out or loaded onto a handheld device for reference later.

However, the directions obtained from such web sites are static. In other words, once downloaded, a user must follow them and manually determine the next event along a route. Further, if the user diverges from the route, the directions downloaded may be irrelevant unless the user backtracks to return to the route.

### SUMMARY OF THE INVENTION

The disclosed embodiments provide devices, methods and systems for providing electronic navigation. Map data can be downloaded from a server through a network, such as the Internet or a cellular telephone network, onto a portable device. The portable device may be a portable device, such as a wireless phone, a personal digital assistant (PDA) or the like. A route may be calculated based on the map data for a starting point and a destination provided by the user. The route may be calculated either by the server or by the portable device. Current positional data may be obtained by the portable device. The current positional data may be obtained through a GPS-enabled device able to communicate with the portable device. Alternatively, the portable device may include a GPS-enabled module for determining the current positional data. The portable device is able to generate directional instructions based on the map data and the current positional information and to provide the user with directional instructions, such as instructions to turn left or right. Thus, the disclosed embodiments provide the user with dynamic and current instructions based on the current position of the user.

In one aspect, the invention includes a navigational method. The method includes downloading map data from a server and generating directional instructions based on the map data and current positional information.

As used herein, “downloading” includes obtaining data or other information from a server. Downloading may including receiving the information through a communication network.

As used herein, “map data” includes geographic data relating to roads, highways, intersections or points of interest, for example. “Map data” may also include routes or directions between a starting point and a destination.

As used herein, a “server” includes a computer or computer software adapted to respond to requests from one or more clients.

“Directional instructions” include one or more steps along a route. Directional instructions may include instructions to turn, exit or the like.

“Current positional information” includes information relating to the current geographic position of a user or a device. Current positional information may be expressed as latitude and longitude. Current positional information may also include altitude.

In one embodiment, the method also includes determining current positional information prior to the step of generating directional instructions. The step of determining current positional information may include using a GPS receiver.

A GPS receiver includes a chipset adapted to receive signals from the constellation of global positioning system (GPS) satellites. The GPS receiver may be adapted to determine a current position via triangulation of such signals.

In another embodiment, the method includes receiving current positional information from a GPS-enabled device prior to the step of generating directional instructions. A “GPS-enabled device” may include a device including a GPS receiver or any device adapted to determine current position based on signals from GPS satellites.

In one embodiment, the method includes a presenting the directional instructions to a user. The step of presenting may include presenting the directional instructions in an alphanumeric display, as an audio output or graphically.

As used herein, “alphanumeric display” includes a display using characters such as alphabet, numbers or other such symbols.

As used herein, “audio output” includes signals adapted to convey an audible message to a user. The signals may be processed through a speaker, for example.

As used herein, “graphically” refers to representation through, for example, a pictorial, schematic or other similar display.

In one embodiment, the step of downloading includes downloading the map data through a network. The network may be the Internet or a wireless telephone network.

As used herein, “network” includes a system of nodes and connections between the nodes. The nodes may include computers provided with server software, for example.

As used herein, “a wireless telephone network” includes a network accessible for wireless telephony. Wireless telephone network may include a cellular network, a personal communication service (PCS) network or other such networks.

In one embodiment, the map data includes directional data to a destination. The directional data may include a route to the destination.

“Directional data” refers to data indicative of a map information between a starting point and a destination. Directional data may also include positional information for objects or streets, for example.

“Destination” refers to a desired end point of travel.

A “route” includes a path of travel between a starting point and a destination.

In one embodiment, the method includes calculating a route based on the map data after the step of downloading the map data.

In one embodiment, the directional instructions include an event along a route to a destination. The event may include a change in direction of travel.

In another aspect, the invention includes a portable device. The portable device includes a map data module adapted to download map data from a server and a navigational module adapted to receive current positional information and to generate directional instructions based on the map data and the current positional information.

As used herein, “module” may be a component, system, subsystem or a mechanism. Further, a module may be a part of one or more components, systems, sub-systems, or mechanisms.

In another aspect, a navigational system includes a map data server adapted to provide map data to requesting clients through a communication network and a portable device adapted to receive map data from the map data server through the communication network and to provide directional instructions to a user. The portable device includes a map data module adapted to receive the map data from the map data server and a navigational module adapted to receive current positional information and to generate directional instructions based on the map data and the current positional information.

### BRIEF DESCRIPTION OF THE DRAWINGS

FIG. 1 is a schematic illustration of an embodiment of a navigational system;

FIG. 2A is a schematic illustration of an embodiment of a portable navigational device;

FIG. 2B is a schematic illustration of another embodiment of a portable navigational device;

FIG. 3 is a flow chart illustrating an embodiment of a navigational method; and

FIG. 4 is a table illustrating exemplary directional information generated according to an embodiment of the invention.

### DETAILED DESCRIPTION OF THE PREFERRED EMBODIMENTS

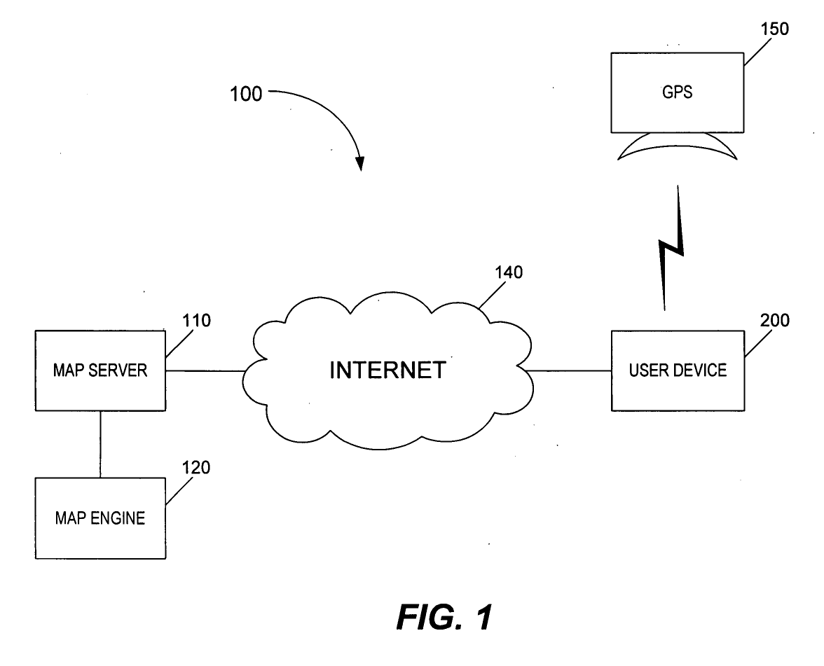

Referring to FIG. 1, an exemplary navigational system according to an embodiment of the invention is illustrated. The navigational system 100 includes a map server 110 in communication with a communication network 140. The map server 110 is adapted to receive requests for map data from one or more client, such as a user device 200, through the network 140. The server 110 may be a computer that is provided with server software. A Web server (not shown) may be provided between the map server 110 and the network 140. The Web server can facilitate communication between the map server 110 and a network, such as the Internet, by converting data from the map server 110 to HTTP format for transmission over the Internet, for example.

Upon receiving a request, the map server 110 may access a map engine 120. The map engine 120 may be a computer or software being executed by a computer adapted to generate map data specific to a request. Thus, for example, the map engine 120 may generate map data for a desired ZIP code or a desired region. In this regard, the map engine 120 may include a database of map-related information, as well as a database server associated with the database. The map engine 120 and the database may be located in separate computers, the same computer as each other or on the same computer as the map server 110.

The communication network 140 may be any network which enables one or more users to access the map server 110. In one embodiment, the network 140 is a public computer network, such as the Internet. In other embodiments, the network 140 may be a telephone network, such as a wireless or cellular telephone network.

One or more users may access the map server 110 through a portable device, such as the user device 200. The user device 200 may be a wireless telephone, a personal digital assistant (PDA), a palm-top device or other hand-held devices. As a portable device, the user device 200 is adapted to be carried by a user.

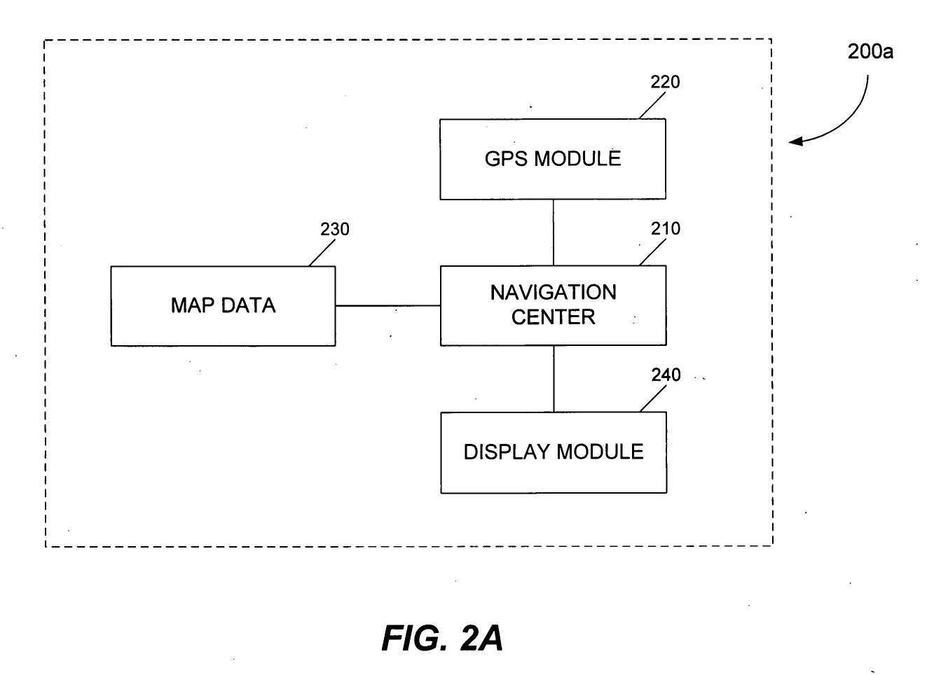

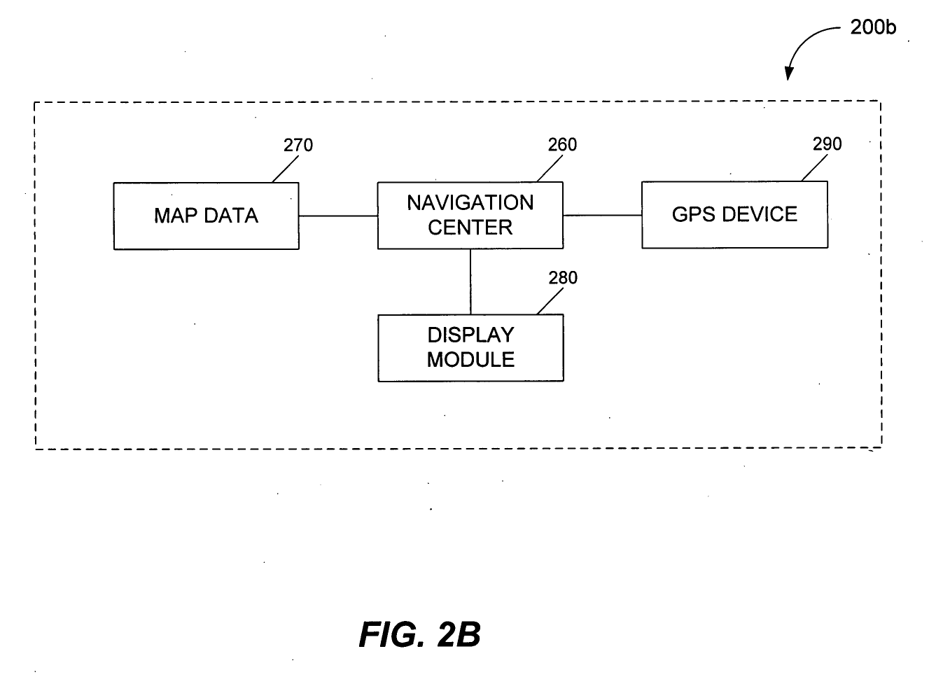

The user device 200 is adapted to receive positional information, such as latitude, longitude and altitude data. In one embodiment, the positional information is based on the Global Positioning System (GPS), which includes a plurality of GPS satellites 150. The user device 200 is adapted to use the positional information and the map data to provide navigational information to the user. Detailed embodiments of the user device 200 are described below with reference to FIGS. 2A and 2B.

FIG. 2A illustrates an embodiment of a navigational device. As described above, the device 200a is a portable device such as a wireless telephone, a PDA or the like. In the illustrated embodiment, the device 200a includes a navigational module 210 adapted to execute and manage navigational functions and to provide a user with navigational instructions. The navigational module 210 is in communication with a map data module 230, a GPS module 220 and a display module 240. The navigational module 210 is adapted to receive data from the map data module 230 and the GPS module 220 and to provide instructions to the display module 240 for presenting navigational information to the user.

Each of the navigational module 210, the map data module 230, the GPS module 220 and the display module 240 may include one or more of hardware, software and firmware. Further, the functions of each of the navigational module 210, the map data module 230, the GPS module 220 and the display module 240 may be divided into two or more modules, or the functions of two or more of the modules 210, 220, 230, 240 may be combined into a single module.

The map data module 230 is adapted to receive map data from a map data server through a communication network, as described above with reference to FIG. 1. In this regard, the map data may be downloaded through a computer network, such as the Internet, or a wireless telephone network, for example. The map data may be received in a format that has been predetermined. In other embodiments, the map data module 230 may be adapted to parse the map data from a server. For example, a server may provide map data to a user as a web page having hyper text markup language (HTML) source code. The map data module 230 may be adapted to scan the HTML source code to parse out the desired map data. Thus, the map data module may be adapted to generate map data for a specified region.

In this regard, map data may include information relating to the location of roads, intersection of roads or the location of points of interest. The map data may be expressed in terms of latitude and longitude. In other embodiments, the map data may be expressed in any one of a variety of manners, such as distance and direction from a fixed point, for example.

The GPS module 220 is adapted to provide current positional information. Thus, the GPS module 220 can provide the navigation center or the user with information relating to the current location of the user or the device 200a. In this regard, the current positional information may be expressed as latitude and longitude. In certain embodiments, the current positional information may also include altitude. Although the illustrated examples refer to the use of GPS, other positioning systems may be used as well and are contemplated within the scope of the invention.

The GPS module 220 may include a GPS receiver adapted to receive and process signals from the GPS satellites in Earth orbit. Such signals allow precise determination of the current position of the device 200a.

The navigation module 210 is adapted to combine the map data from the map data module 230 and the current positional information from the GPS module 220 to generate directional instructions for a given destination. In this regard, the navigational module 210 may be adapted to calculate directional data, such as a route, to the destination from the current position.

In other embodiments, the directional data may be included in the map data downloaded from the map data server. In these embodiments, the user may provide a starting point and a destination to the map data server. The starting point may be provided as the current position through the GPS module 220. The map data server may calculate a route based on the starting point and the destination and provide the calculated route as part of the map data.

The route may include one or more events requiring the attention of the user. Accordingly, the navigational module 210 may provide directional instructions relating to the event to the user, as described below.

The navigational module 210 may continuously monitor the current position of the device 200a using the current positional information from the GPS module 220. Based on the calculated route, the navigational module 210 may detect an upcoming event along the route. An event may include an upcoming turn or an exit, for example, requiring the attention of the user. When such an upcoming event is detected, the navigational module 210 may send a signal to the display module 240 requesting the event be presented to the user. The signal to the display module 240 may include information relating to the upcoming event and the instructions to be presented to the user.

The display module 240 is adapted to present the directional instructions to the user. In this regard, the display module 240 may include a graphical user interface which presents the directional instructions to the user graphically or in an alphanumeric display. In presenting the instructions graphically, the display module 240 may display a map with an arrow indicating the directional instructions, for example. In an alphanumeric display, the display module 240 may display street names, route numbers or other identifiers along with an instruction such as “TURN LEFT,” “TURN RIGHT” or “NEXT EXIT,” for example. In another embodiment, the display module 240 provides the directional instructions through an audio output, such as a speaker. In this regard, a synthesized voice may be pre-programmed to provide the user with the directional instructions.

Thus, based on downloaded map data and current positional information, the user is provided with directional instructions to a desired destination.

FIG. 2B illustrates another embodiment of a navigational device. In this embodiment, the navigational device 200b includes a navigational module 260, a map data module 270 and a display module 280, similar to corresponding modules described above with reference to FIG. 2A. The device 200b does not include a GPS module. Instead the navigational module 260 of the device 200b is adapted to receive current positional information from another device, such as a GPS-enabled device 290. In this regard, the device 200b is adapted for short-range wireless communication with the GPS-enabled device 290. For example, the navigational device 200b and the GPS-enabled device 290 may be Bluetooth-enabled for short-range communication. Thus, the navigational module 260 receives the current positional information from the GPS-enabled device 290 and map data from the map data module 270 for generation of directional instructions.

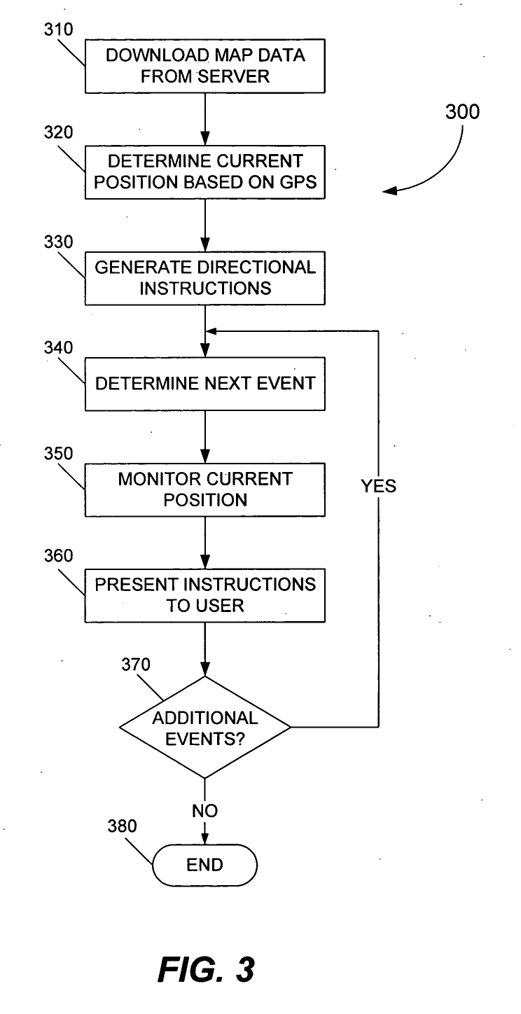

FIG. 3 illustrates an exemplary navigational method. In the illustrated method 300, map data is downloaded from a map data server (block 310), and current positional information is determined (block 320). As noted above, the current positional information may be determined based on the global positioning system (GPS). Based on the map data and the current positional information, directional instructions can be generated (block 330). In one embodiment, the user may provide a starting point, which may be the same as or different from the current position, and a destination. An optimal route may be calculated based on the starting point, the destination and the map data.

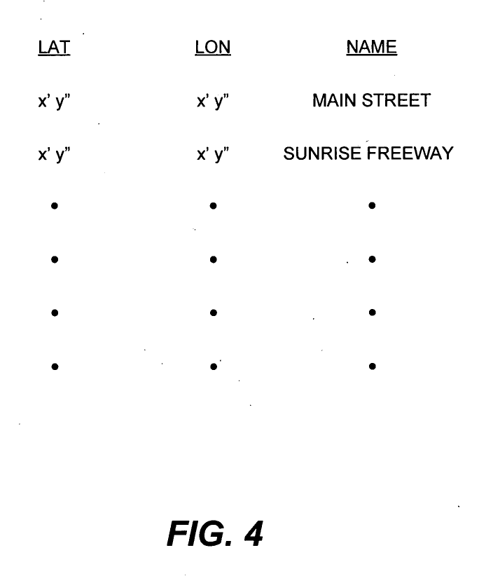

The directional instructions may include a series of events along a route, for example. The events may be expressed in numerous ways, including instructions such as “TURN LEFT,” “TURN RIGHT” or “NEXT EXIT.” In another embodiment, the directional instructions may be expressed as illustrated in FIG. 4. In this example, the directional instructions include information relating to route segments including distances along each segment. Each segment information includes a starting point for the segment expressed as a longitude and a latitude. The segment information may also include certain information relating to the segment. In the example illustrated in FIG. 4, the segment information includes the name of each segment. In other embodiments, other information, such as type of road or information relating to a point of interest, may be included. A travel direction along that segment, such as north, south, east or west, and a distance to be traveled along that segment may be calculated using the map data and the latitude/longitude information of adjacent segments. In this regard, an event may be defined when the calculated distance has been traveled along that segment.

Referring again to FIG. 3, the method 300 includes determining the next event in the directional instructions (block 340). With the next event determined, the current position is monitored (block 350) for the upcoming event. As the event is approaching (e.g., the end of the segment), instructions are presented to the user (block 360). In this regard, the instructions may be presented at a predetermined distance or time before the occurrence of the event. For example, the instructions may be presented to the user when the current position is less than or equal to 1000 feet from the end of the segment.

Once the event has passed and the current position is on the next segment, the method 300 determines whether additional events remain (block 370). If additional events remain, the method 300 returns to block 340, and the next event is determined. If no additional events remain, it is determined that the destination has been reached. Accordingly, the method 300 proceeds to block 380 and terminates.

Thus, the disclosed embodiments provide devices, methods and systems for providing electronic navigation. The embodiments are able to generate directional instructions based on downloaded map data and current positional information and to provide the user with directional instructions, such as instructions to turn left or right. Thus, the disclosed embodiments provide the user with dynamic and current instructions based on the current position of the user.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A navigational method, comprising:
downloading map data from a server; and
generating directional instructions based on the map data and current positional information.

2. The method of claim 1, further comprising:
determining current positional information prior to the step of generating directional instructions.

3. The method of claim 2, wherein the step of determining current positional information includes using a GPS receiver.

4. The method of claim 1, further comprising:
receiving current positional information from a GPS-enabled device prior to the step of generating directional instructions.

5. The method of claim 1, further comprising:
presenting the directional instructions to a user.

6. The method of claim 5, wherein the step of presenting includes presenting the directional instructions in an alphanumeric display.

7. The method of claim 5, wherein the step of presenting includes presenting the directional instructions as an audio output.

8. The method of claim 5, wherein the step of presenting includes graphically presenting the directional instructions.

9. The method of claim 1, wherein the step of downloading includes downloading the map data through a network.

10. The method of claim 9, wherein the network is the Internet.

11. The method of claim 9, wherein the network is a wireless network.

12. The method of claim 1, wherein the map data includes directional data to a destination.

13. The method of claim 12, wherein the directional data includes a route to the destination.

14. The method of claim 1, further comprising:
calculating a route based on the map data after the step of downloading the map data.

15. The method of claim 1, wherein the directional instructions include an event along a route to a destination.

16. The method of claim 15, wherein an event includes a change in direction of travel.

17. A program product, comprising machine readable program code for causing a machine to perform the following method steps:
downloading map data from a server; and
generating directional instructions based on the map data and current positional information.

18. The program product of claim 17, further comprising machine readable program code for causing a machine to perform the following method step:
determining current positional information prior to the step of generating directional instructions.

19. The program product of claim 17, further comprising machine readable program code for causing a machine to perform the following method step:
receiving current positional information from a GPS-enabled device prior to the step of generating directional instructions.

20. The program product of claim 17, further comprising machine readable program code for causing a machine to perform the following method step:
presenting the directional instructions to a user.

21. The program product of claim 17, wherein the step of downloading includes downloading the map data through a network.

22. The program product of claim 17, further comprising machine readable program code for causing a machine to perform the following method step:
calculating a route based on the map data after the step of downloading the map data.

23. A portable device, comprising:
a map data module adapted to download map data from a server; and
a navigational module adapted to receive current positional information and to generate directional instructions based on the map data and the current positional information.

24. The device of claim 23, further comprising:
a position module adapted to determine current positional information and to communicate the current positional information to the navigational module.

25. The device of claim 24, wherein the position module includes a GPS receiver.

26. The device of claim 23, wherein the navigational module is adapted to receive current positional information from a GPS-enabled device.

27. The device of claim 23, further comprising:
a display module adapted to present the directional instructions to a user.

28. The device of claim 27, wherein the display module is adapted to present the directional instructions in an alphanumeric display.

29. The device of claim 27, wherein the display module is adapted to present the directional instructions as an audio output.

30. The device of claim 27, wherein the display module is adapted to graphically present the directional instructions.

31. The device of claim 23, wherein the map data module is adapted to download the map data through a network.

32. The device of claim 31, wherein the network is the Internet.

33. The device of claim 31, wherein the network is a wireless telephone network.

34. The device of claim 23, wherein the map data includes directional data to a destination.

35. The device of claim 34, wherein the directional data includes a route to the destination.

36. The device of claim 23, wherein the map data module is adapted to calculate a route based on the map data.

37. The device of claim 23, wherein the directional instructions include an event along a route to a destination.

38. The device of claim 37, wherein an event includes a change in direction of travel.

39. A navigational system, comprising:
a map data server adapted to provide map data to requesting clients through a communication network; and
a portable device adapted to receive map data from the map data server through the communication network and to provide directional instructions to a user, wherein the portable device comprises:
a map data module adapted to receive the map data from the map data server; and
a navigational module adapted to receive current positional information and to generate directional instructions based on the map data and the current positional information.

40. The system of claim 39, wherein the portable device further comprises:
a position module adapted to determine current positional information and to communicate the current positional information to the navigational module.

41. The system of claim 39, further comprising:
a GPS-enabled device adapted to determine current positional information and to communicate the current positional information to the portable device.
